(19) United States
(12) Patent Application Publication
(10) Pub. No.: US 2010/0114679 A1
(43) Pub. Date: May 6, 2010

(54) PROGRAMMABLE ADVERTISING PANEL POWERED BY SOLAR CELLS AND COMMUNIATION MEANS THEREOF

(76) Inventor: Yang Pan, (US)

Correspondence Address: Yang Pan;Intellectual Power Pte Ltd, No. 14 Robinson Road #06-01,, Far East Finance Building, Singapore, 048545, SG

(21) Appl. No.: 12/263,472

(22) Filed: Nov. 2, 2008

(51) Int. Cl. G06Q 30/00; G06F 3/038; G06T 1/00

(52) U.S. Cl. 705/14.4; 345/211; 345/522

(57) ABSTRACT

A programmable display apparatus powered by solar cells is disclosed. The apparatus is with high portability and may be deployed to render advertising messages at isolated locations outdoor. Multiple solar cells are arranged on the device either underneath a transparent or a semi-transparent display panel and/or in areas uncovered by the panel. The solar cells arranged underneath the display panel may have a larger area than the panel, which allows the solar energy is collected with an enlarged solar cell arrays while maintaining the portability of the device. A communication device is integrated with the display system to provide means to communicate with an external device or a communication network. According to one embodiment, visible light communication is employed to deliver updated advertising messages and control data to the display system outdoor. According to one implementation of the embodiment, at least one solar cell connected to a voltage or a current sensing circuit is used as a photo detector to receive the modulated visible light beam and to convert the signals into electrical ones.

### CROSS-REFERENCE TO RELATED APPLICATIONS

Not applicable.

### BACKGROUND

1. Field of Invention

This invention relates generally to solar cells. More specifically, the invention relates to method and system for providing advertisements by employing an outdoor display system powered by solar cells.

2. Description of Prior Art

Solar cells convert light into electricity, and they are typically made of semiconductor materials. Solar cells have been around for many years, but its commercial use has been very limited. This is partly due to economic reasons. The cost of generating a unit amount of energy using currently available solar cell technologies is still more expensive than using other alternative technologies such as those based on fossil fuels. For some applications, however, solar power can be viable option. Some devices, such as handheld Global Positioning System (GPS) units, are designed to be used outdoors and therefore they can be more suitable to be powered by solar energy. One of additional benefits of using renewable energies such as solar power is that they are “clean” and environmentally friendly.

Some prior art devices use solar cells to generate electrical power for portable devices. A handheld calculator with a built-in solar cell has been in market for many years. The solar cell is typically placed underneath a display for the calculator.

U.S. Pat. No. 5,936,380 to Parrish describes a system for prolonging life of a battery-powered laptop or notebook computer. Solar cells are incorporated into the chassis or display screen of a notebook computer so that the solar cells can provide power to any component of the notebook computer and/or help with the charging, powering, and/or regulation of a battery used as a power source.

U.S. Pat. No. 6,847,834 to Leem discloses a mobile terminal with a solar cell. The solar cells are attached to the outer surface of a flip cover to be exposed to the light and to generate electricity. US patent application publication No. 2008/0094025 by Rosenblatt et al. discloses an art to integrate solar cells into a portable device. Multiple cells are arranged on the surface of the device such that a number of solar cells may always be functional and produce a desirable voltage even if the rest is obstructed.

Solar cells have also been used to power illuminating device outdoor for advertising signs. U.S. Pat. No. 4,484,104 to O'Brien discloses a solar powered lighting system suitable for signs, hoardings, navigation and billboards. U.S. Pat. No. 5,329,716 to Fite discloses an outdoor advertising bench for displaying advertising message. U.S. Pat. No. 5,947,584 to Passanante et al. discloses an illuminated trash receptacle for rendering advertisement which is displayed on the side walls of the receptacle.

US patent application publication No. 2007/0277810 by Stock discloses an art that a solar panel and an element comprising a visually distinguishable feature. The nature of the visually distinguishable feature and/or the location of the element relative to the solar cells does not completely prevent sun light incident on the panel front from being incident on at least a portion of array.

US patent publication No. 2006/0042679 to Choi et al. discloses a self-contained portable solar power supply system for illuminating advertising graphics and messages installed on waste receptacles disposed on city street curbs.

U.S. Pat. No. 6,104,372 to Lindquist et al. discloses a solar cell driven display wherein a display device comprising at least one electro-chromic cell, at least one-photochemical cell, a solar cell, and a battery and are formed integrally with each other. US patent publication No. 2007/0089784 by Noh et al. discloses a solar cell driven display device using a dye-sensitized solar cell. The solar cell-driven display device exhibits the display device function using only sun light and the device can therefore be used in isolated areas for advertising.

As illustrated above, integrating solar cells with portable devices and portable panels for the outdoor advertising is known in prior art. Several disadvantages associated with the prior art may prevent their commercial implementations. It may not increase the battery lifetime in a significant manner for a handheld device by integrating solar cells due to the fact that a user places the device in one's pocket at most of the time. The area and the time for the solar cells to be exposed to sun light are limited. Advertising panel integrated with solar cells may provide practical means when used in isolation. Improved design, however, is required to maximize the power acquired from solar cells. Furthermore, the display device driven by solar cells may be expanded into a computing and communicating device, which opens up more applications by programming the displayed contents in a real time base.

### SUMMARY OF THE INVENTION

It is an object of the present invention to provide a portable display system powered by solar cells and a rechargeable battery. The display system comprises a display panel, a processor, a file storage system and a communication device communicating with an external device or a communication network.

It is another object of the present invention to provide improved designs for the portable display system for rendering advertising messages. Various embodiments for integrating solar cells with the display panels are disclosed to provide improved power collection for the system operation.

It is yet another object of the present invention to provide a method of programming operation of broadcasting of the display system wirelessly. Instructions are provided by an external mobile device.

It is still yet another object of the present invention to provide a method of programming through a manner of optical communication between the display system and the external device, wherein the external device emits a modulated light beam towards the display panel and the display system has at least one solar cell used as a receiving photo-diode. The received optical signals are converted into electrical signals and are stored in the storage system under the control of the processor.

The present invention relates to various methods, structures, systems, articles of manufacture, and apparatuses for using solar cells with programmable display panels. In embodiments of the present invention, solar cells are integrated into portable display panels.

According to one embodiment, the solar cells and a liquid crystal display (LCD) layer are coupled mechanically and electrically to a flexible printed circuit board (PCB) layer. The LCD layer occupies a portion of the panel and the solar cells occupy other part of the panel so the display layer does not block the light penetration into the solar cells. The power produced from the solar cells is transferred to the PCB layer. The solar cells and LCD layer are covered by a layer made of transparent or semi-transparent materials, which serves, among other things, as protective layers. The layer is glued with shock absorbent materials.

In another embodiment, the solar cells are stacked with other layers such as LCD layer. The solar cells are placed underneath the LCD layer, which is transparent or semi-transparent. The solar cells are coupled mechanically and electrically to the PCB layer. In such an implementation, various layers made of transparent or semi-transparent materials, which are glued with shock absorbent materials.

In yet another embodiment, the solar cells are installed underneath the LCD layer. The solar cell layer, however, is larger than the LCD layer. For a typical implementation, the LCD is located in the central of the panel. The LCD is surrounded by extra solar cells in its peripheral areas. The design, allows the extra solar energy is collected to support the operation of the display system.

The programmable display system further includes a processor, a file storage system, a communication device and a rechargeable battery. The system as supplied by the solar cells can be deployed in isolation in the field. For example, the system may be installed on a wall of a building, which is exposed to the sun light. The system may also be installed on a pole, which supports street light. The system may also be installed on a side wall of a vehicle. The display system is portable and can be moved around.

An energy flow control module is used to optimize the usage of the solar energy and the rechargeable battery. When the display system is operating, the collected solar energy is measured. If the energy is sufficient for powering the system, the electrical power converted from the solar energy is then directed to supply power for the system operation. The surplus power is then directed to charge the re-chargeable battery. If the energy is insufficient for powering the system operation, the converted solar energy is then supplemented by the power from the battery for the system operation. If the display system is idle, the electrical power from solar cells is used to charge the battery.

The operation of the display system for broadcasting an advertising message is controlled by the processor which is a low-power microprocessor in our preferred embodiment. The display system may include a number of media contents stored in its storage system before it is deployed into the field. A program stored in the system controls the operation of broadcasting. The contents to be broadcasted as well as the time for rendering the contents may be programmed. An external device may communicate with the display system through wireless or optical means.

As an exemplary case, the external computing device may be with a mobile station carried by a vehicle operated by an advertising broker or an advertiser. The external computing device establishes a wireless communication channel with the display system when it is approaching the display system. Each external device has a unique identity code. The external device identifies itself to the display system after the communication channel is established. The external device then transmits advertising messages and control data to the system. The communication device of the system receives the messages and the data and stores them in the file storage system under the control of the processor. The broadcasting program is updated by the processor based upon the received advertising messages and the control data.

According to another embodiment, the communication between the display system and the external computing device is accomplished by the use of the optical communication means. The external device is with an optical signal transmitter, which emits a light beam towards the display system. The light beam is modulated by the external device carrying signals comprising the advertising messages and the control data. The light beam may use a visible or an invisible light. The light beam may be generated by Light Emitting Diode (LED). A photo detector in the display system receives the optical signals. In one embodiment, at least one solar cell is used as a photo detector to receive the incoming optical signals. A solar cell is a diode, which converts the light into electrical current by utilizing well known photovoltaic effect. The solar cell (photo detector) connected to a voltage or a current sensing circuit is able to detect the variation of the light intensity when the diode is exposed to a modulated light beam. The signal may be detected even when the cell is used as the solar cell converting sun light into electricity concurrently. Multiple solar cells may be configured to operate as photo detectors.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIGS. 1A to 1C illustrate exemplary embodiments of a display system. FIG. 1A shows the solar cells are arranged in the peripherals of a display layer. FIG. 1B shows the solar cells are arranged underneath a display layer. FIG. 1C shows the solar cells are arranged underneath the display layer and the solar cells occupy a larger area than the display layer does.

FIG. 2 illustrates an exemplary structure of a display panel according to an embodiment of the present invention. The solar cell layer shown in the figure is arranged underneath a display layer and the solar cell layer is larger than the display layer.

FIG. 3 represents an exemplary process for constructing a display panel including a solar cell layer according to an embodiment of the present invention.

FIG. 4 is a schematic diagram of a programmable display panel including various functional blocks according to an embodiment of the present invention. The energy flow control module is used to control the energy flow supplying the system operation from solar cells and from a rechargeable battery.

FIG. 5 shows a block diagram illustrating various functional modules for controlling the energy flow from solar cells and from the rechargeable battery.

FIG. 6 is a flow chart illustrating an exemplary process for energy flow management according to an embodiment of the present invention.

FIG. 7 is a schematic diagram illustrating that portable display panel may be installed on a wall of a building (top figure) and on a pole for a street light (bottom figure).

FIG. 8 is a schematic diagram illustrating a wireless communication between a programmable display system and an external device.

FIG. 9 is a flow chart for a process that signals are received by a display system from an external device through short range wireless communication devices according to an embodiment of the present invention.

FIG. 10A is a schematic diagram illustrating an optical communication between a programmable display system with a photo detector and an external device with an optical transmitter.

FIG. 10B is a schematic diagram illustrating a display panel including a plurality of photo detectors. Solar cells are used to supply power for the system. Some solar cells are configured as photo detectors according to an embodiment of the present invention.

FIG. 11 is a schematic diagram illustrating a displayed system receiving signals through a light beam, which is coded by modulating of the intensity of the light beam according to an embodiment of the present invention.

FIG. 12 is a flow chart for a process that signals are received by a display system from an external device through optical communication means according to an embodiment of the present invention.

### DETAILED DESCRIPTION

References will now be made in details to a few embodiments of the invention, examples of which are illustrated in the accompanying drawings. While the invention will be described in conjunction with the particular embodiments, it will be understood that it is not intended to limit the invention to the described embodiments. To the contrary, it is intended to cover alternatives, modifications, and equivalents as may be included within the spirit and scope of invention as defined by the appended claims.

In various embodiments of the present invention, media contents or advertising messages may include text, graphics, video, audio and multimedia messages. It should be appreciated that while advertisement messages are used herein as exemplary embodiments of the invention, any document may be used in accordance with the various embodiments. It should be understood that an advertisement as used herein may comprise audio and/or video signals, static and/or dynamic images, graphics, video, film, or other content that relate to one or more products, services, and/or entities, such as commercial entities. Advertisements may also comprise various visual features, including animation, sound etc., and may include text, such as in a text advertisement. Thus, the term “advertisement” is used herein in its broadest sense to include any content or object intended for observation, use, or consumption by one or more persons for the purpose of marketing or promoting a product or service.

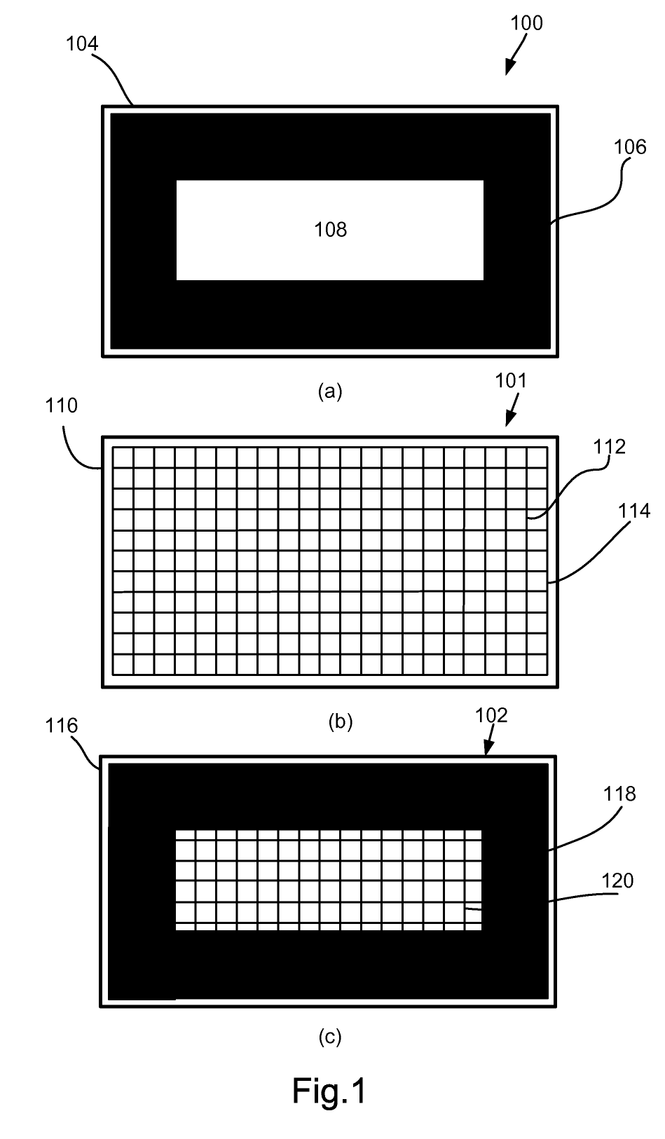

With reference now to figures, FIGS. 1A, 1B and 1C illustrate exemplary embodiments of the programmable display system. As shown in FIG. 1A, one embodiment of the display system 100 includes a frame 104, a solar cell layer 106 and a display layer 108. The solar cell layer 106 comprises a plurality of solar cells. The solar cells may be connected in parallel or in series to provide sufficient voltage and current for the operation of the system. The display layer 108 is a Liquid Crystal Display (LCD) in an exemplary case. The display layer 108 may also be other devices of display such as, for example, an array of Light Emitting Diode (LED). The solar cell layer 106 and the display layer 108 are mounted onto a flexible Printed Circuit Board (PCB). The frame 104 is typically made of solid materials such as a metallic material to provide mechanical support for the display layer 108 and solar cell layer 106 as well as other components of the system. The implementation, which places the solar cell layer 106 in the areas that are not obstructed by the display layer 108, has an advantage of simple for manufacture. The power acquired from sun light may be adjusted by increasing or reducing the area covered by the solar cells to meet the system power consumption requirements.

FIG. 1B illustrates another embodiment of the present invention. The display system 101 comprises a frame 110 and a display layer 112. The solar cell layer 114 is placed underneath the display layer 112. In an exemplary case, the display layer 112 and the solar cell layer 114 overlap each other nearly fully and occupy approximately all area enclosed by the frame as shown in FIG. 1B. The embodiment maximizes the panel area for display and the area for collecting solar energy. However, it requires a more complex manufacturing process to stack the display layer 112 and a solar cell layer 114. Both of them are stacked on the top of a flexible PCB and are also connected to the PCB.

FIG. 1C illustrates yet another embodiment of the present invention. The display system 102 comprises a frame 116, a solar cell layer 118 and a display layer 120. The solar cell layer 118 occupies approximately the area enclosed by the frame 116. The display layer 120 overlaps the solar cell layer 118 and is smaller in size in both horizontal directions. The display layer 120 is stacked on the top of the solar cell layer 118. The sun light is able to penetrate through a transparent or semi-transparent layer such as, for example, a LCD layer for display.

In certain embodiments of the present invention, the solar cell layer is stacked with other layers that provide various functions. For example, in a typical design, the solar cell layer is coupled mechanically and electrically to a flexible PCB. The electric power produced from the solar cells is transferred to the PCB layer, which supply power to the rest of the system. In some embodiments, the solar cell layer is stacked with layers made of transparent or semi-transparent materials, which serve, among other things, as protective layers. These layers may be glued with shock absorbent materials. Some of these layers may be used for display or input purposes. Structures comprising these layers including solar cell layer may be attached, for instance, to the frame of the display system using shock absorbing glues.

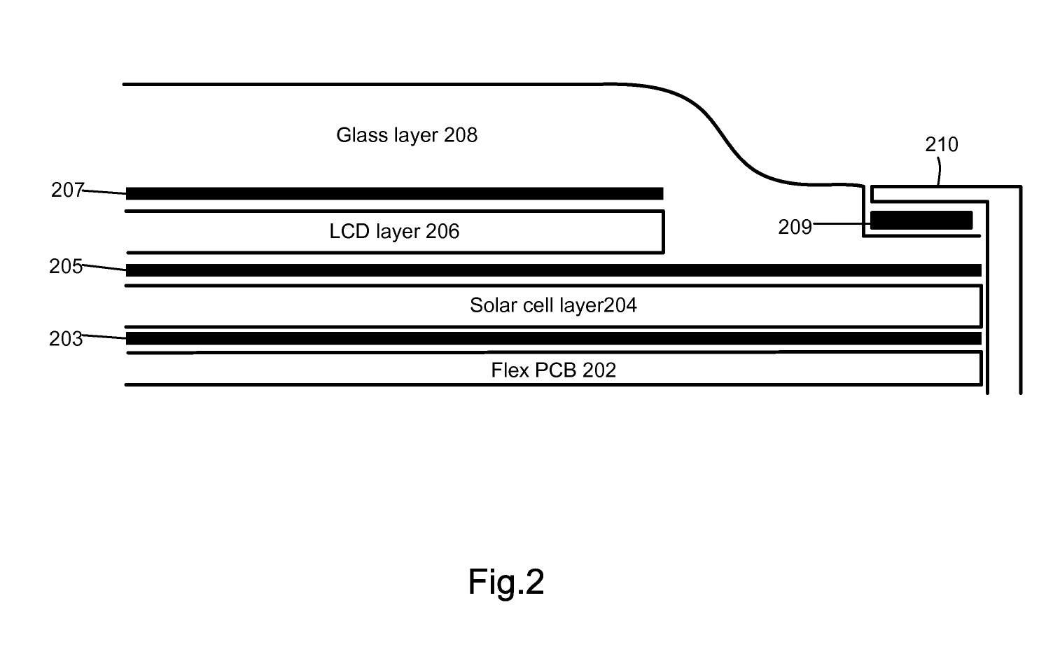

FIG. 2 shows a structure of an exemplary display system in according to the embodiment as illustrated in FIG. 1C. The figure schematically depicts a cross section of the display system. The exemplary display system as shown in FIG. 2 includes four layers 202, 204, 206 and 208, which are ties to each other through glue, 203, 205 and 207. In some embodiments, shock absorbing glue is also used to stick these layers together. The glue used should be transparent or near transparent so as not to block light from reaching solar cells. The solar cell layer 204 is attached to a flexible PCB layer 202 through glue 203. The solar power generated from solar cell layer 204 is transferred to electric circuits in the flexible PCB layer 202. The electric power is then transferred to main parts of the system to power various components. The outmost layer 208 serves, among other things, as a protective layer. The extra layer 206 is used for display purposes. In an exemplary illustration, a transparent or semi-transparent LCD layer is used. The multiple layers tied together may be attached to a frame 210 through glue 209. The frame 210 is typically made of solid materials such as a metallic material.

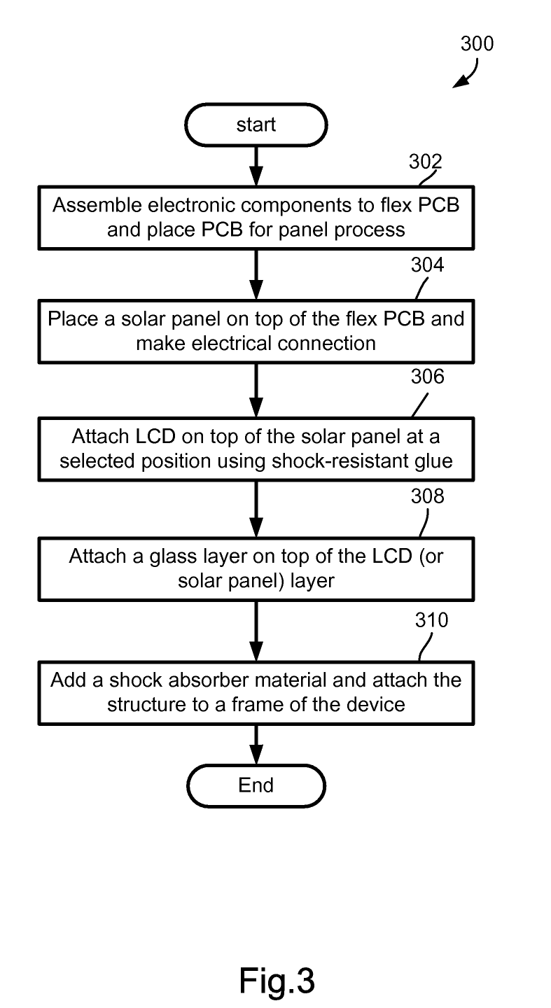

FIG. 3 shows an exemplary flow chart for constructing a display panel powered by the solar cells. The chart starts from the bottom layer and moves upwards with the structure shown in FIG. 2. As shown in the chart, the display panel structure is built by first placing a flexible PCB layer at 302. The solar cell layer is then stacked on top of flexible PCB at step 304. Electric connections are made at the step. A display layer such as a LCD layer is then stacked on the top of the solar panel in step 306 using shock-resistant glue. The display layer (LCD) is smaller than the solar cell layer in at least one embodiment of the present invention. The display layer is placed at the center portion of the structure stacked with the solar cell layer and the flexible PCB. One or more glass or plastic layer is then glued on top of LCD layer as indicated at 308. The transparent glass or plastic layers may be coated or laminated before they are attached to the structure. The structure is attached, at 310, to the frame using, for example, shock absorbing glue.

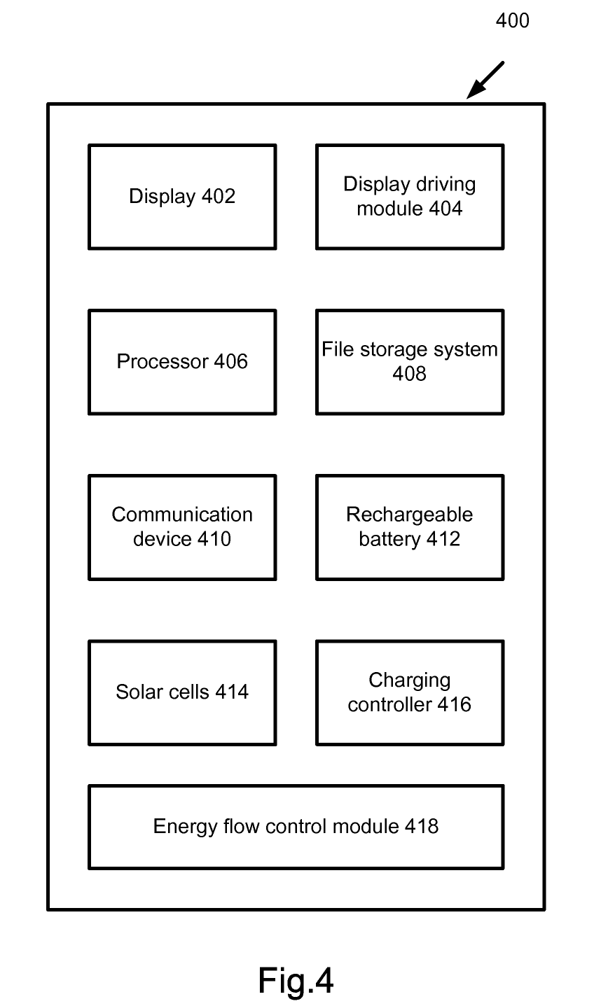

Now turning to FIG. 4, a block diagram is shown illustrating various components of an exemplary programmable display system. The system may be viewed as a computing and communication system powered by solar cells and a re-chargeable battery. As will be appreciated by one of skill in the art, however, the present invention may be embodied as a method, a computing and communication product as well as an article of manufacture or an apparatus. Thus the scope of the invention should be determined by the appended claims and their legal equivalents, and not by examples given. Note that while the block diagram of FIG. 4 illustrates various components of a programmable display system, it is not intended to represent any particular architecture or manner of interconnecting the components.

As shown in FIG. 4, the exemplary programmable display system 400 includes a display 402 and a display driving module 404. The display 402 may be a LCD screen. The display 402 may also be a LED array. The driving module 404 is an electric circuit which generates a suitable electric voltage for the operation of the display. The present invention applies to various display types which can be used to display a media content including advertising messages. The programmable display system further includes a processor 406, which is a low power microprocessor in our preferred embodiment. The processor 406 controls overall operation of the system including communication with external devices and programming the broadcasting of the media contents.

The display system also includes a file storage system 408 for storing media contents and other data. A file storage system may include a mass storage device such as a magnetic hard drive or a magnetic optical drive or a semiconductor flash memory device or devices. The file storage system 408 may also include a cache for fast data access. A cache may be made of volatile memory such as DRAM.

The system includes a communication device 410. The communication device is used to communicate with an external device or a communication network including the Internet. In one implementation of the present invention, the communication device is a wireless communication device including a transceiver. The programmable display system may communicate with a server connected to the Internet. In such an implementation, the display system is a computing device connected to the Internet. In another implementation, the display system communicates with an external device through a means of short range communication. It should be noted that various short range communication methods may be used such as the ones conforming to various IEEE standards and their amendments including IEEE 802.11 and/or IEEE 802.15.1 and/or IEEE 802.15.4.

In another embodiment of the present invention, the communication device 410 is an optical communication module including an optical signal receiver such as a photo detector. The external device includes a light modulator. A modulated light beam emitted from a transmitter is received by the photo detector and is decoded accordingly.

The system includes a rechargeable battery 412 and a solar panel 414. The rechargeable battery 412 is a deep cycle battery in our preferred embodiment. The solar panel 414 comprises a plurality of solar cells, which are connected in parallel or in series to provide a suitable voltage and current for the system operation or for the charging of the battery 412. A charging controller 416 controls the operation of charging the battery. An energy flow control module 418 is used to control the energy flow generated from solar panel and from the battery for the operation of the system.

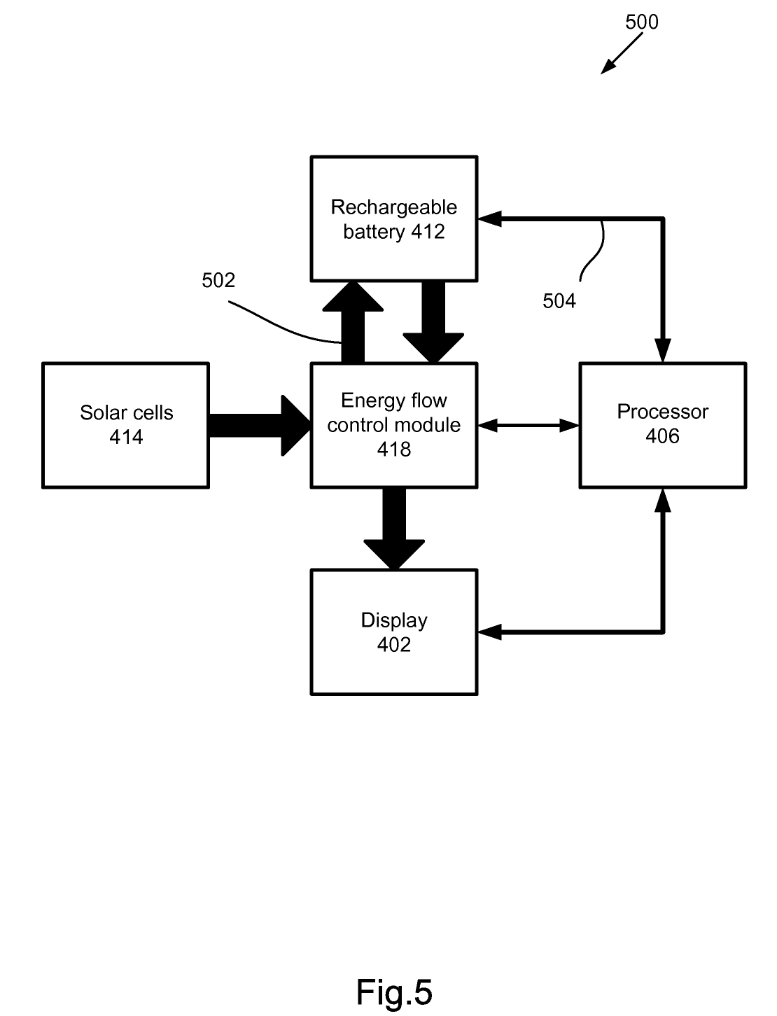

As shown in FIG. 5, a block diagram illustrates the operation of the energy flow control module including various function modules according to an embodiment of the present invention. As shown in the figure, arrows 502 with thicker lines indicate energy flows and arrows 504 with thinner lines indicate signal flows. The energy flow control module 418 is a schematic representation of a (virtual) unit responsible for “traffic control” of electricity flow in the system. The unit may or may not be a concrete unit including circuit elements. In some embodiments, the circuits may include boost converter to change the voltage coming from the solar cells 414 to a value suitable for the battery 412, the display 402 and other components in the system. The electricity generated from solar cells 414 can be used either to charge up the battery 412 or to supply the system operation. The processor 406 controls the operation of directing right amount of powers for the system operation while utilizing the solar cell generated power fully. It may also help to direct the surplus power generated from solar cells to charge the battery 412.

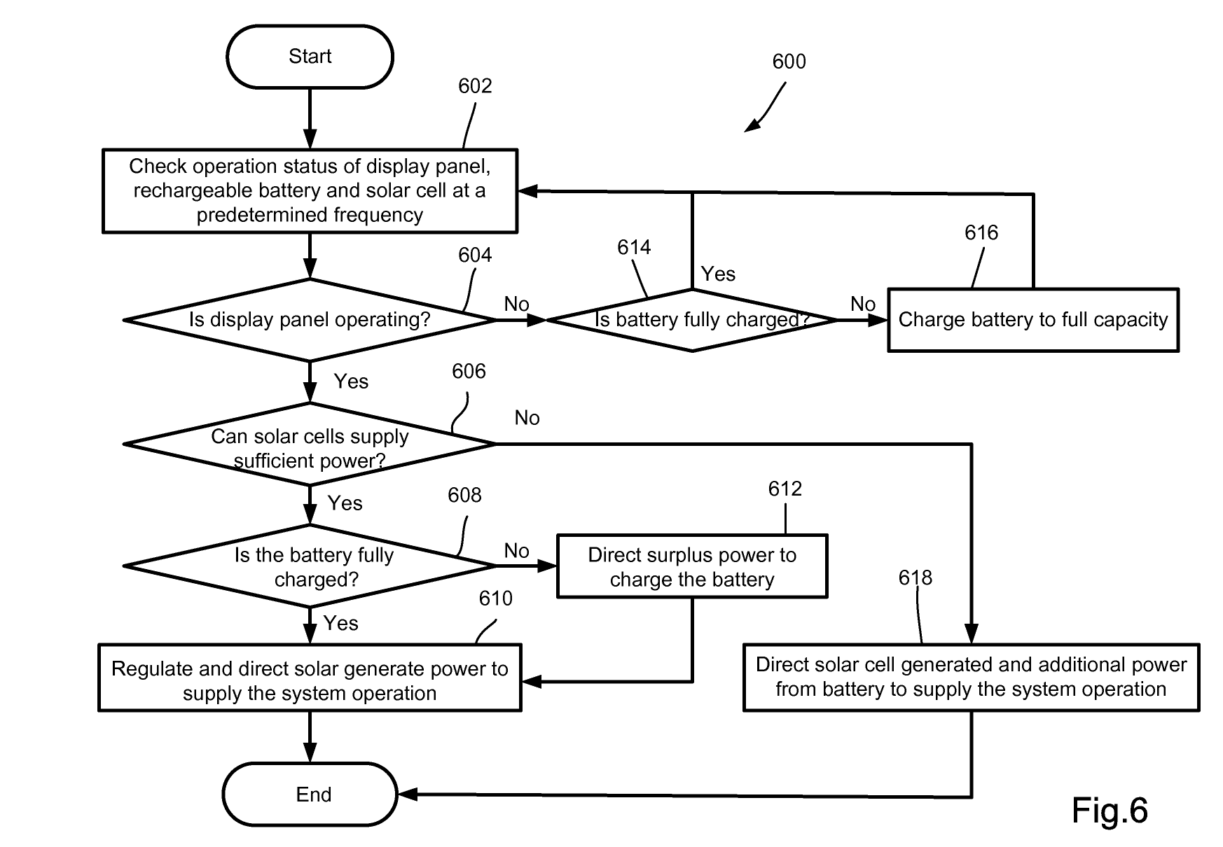

FIG. 6 is a flow chart illustrating an exemplary process for energy flow management according to an embodiment of the present invention. As with the energy flow control module 418, the process 600 starts with a step 602 that the processor 406 checks the status of the display 402, the rechargeable battery 412 and the solar cells 414 in a predetermined frequency. If the processor finds that the display 402 is operating at 604, it then checks at 606 if the electricity generated from solar cells is sufficient for supplying power for the display and for other components. If the solar cells 414 do provide sufficient electricity for the system operation, the processor checks if the battery is fully charged at 608. If the results is positive, the electricity generated is fully used for the system operation at 610 otherwise the surplus electricity generated from the solar cells 414 is used to charge up the battery 412 at 612. At 604, if the processor finds that the display is idle, the electricity generated from the solar cells 414 is directed at 614 and 616 to charge up the battery and provides power for other components of the system. At 606, if the processor finds the display 402 is operating while the solar cells 414 cannot provide sufficient electricity such as because of poor weather conditions, the processor 406 at 618 directs all electricity generated from the solar cells 414 and additional power from the battery 412 to supply the electricity required for the system operation.

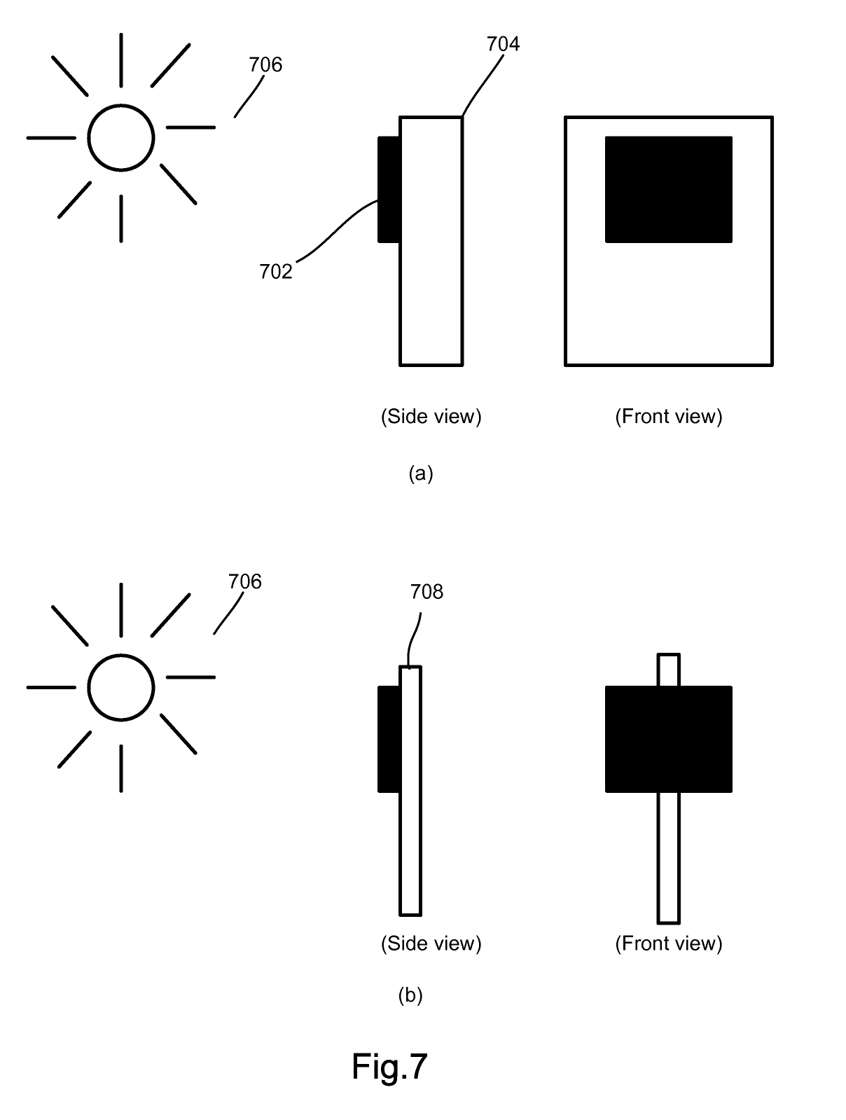

According to one embodiment of the present invention, the programmable display system is a portable panel powered by solar cells. It can be deployed outdoor in isolation for rendering media contents such as advertising messages. The system collects solar energy at day time with exposure to the sun light and stores the energy in the rechargeable battery. The system broadcasts the messages at night or at day time as programmed. As shown in FIG. 7, the top figure illustrates that the portable display panel 702 may be installed on a wall of a building 704 and be exposed to the sun light 706 at day time. The bottom figure illustrates that the portable display panel 702 may be installed onto a pole 708 for supporting a street illuminating device. The portable display panel can be installed at any place exposed to the sun light 706 and is visible to various passengers.

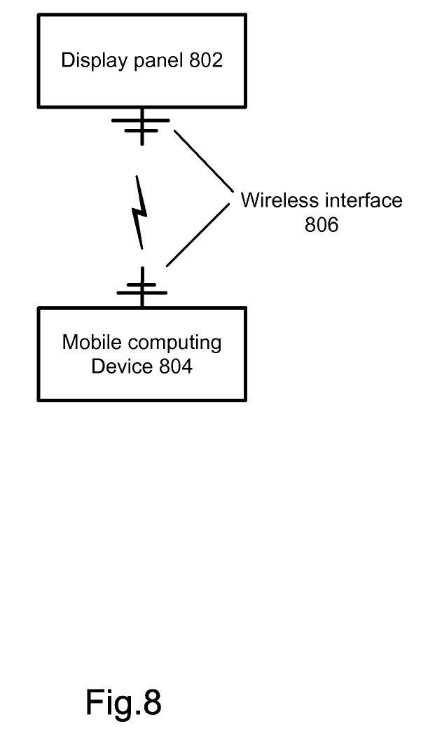

Before a programmable display system is deployed for an outdoor application, the file storage system 408 may be loaded up with media contents to be broadcasted. Programs controlling operations of the system may also be loaded up to the system. The battery 412 is charged up by an external source. During the operation lifetime of the system, it may be necessary that the media contents and the programs are modified. It is desirable that the display system can communicate with an external device to receive the updated media contents and data related to the system operation. Therefore, it may not be necessary that the system is removed from a wall or a pole. It may also not be needed for a user to be in contact with the system physically. FIG. 8 is a schematic diagram illustrating a wireless communication between a programmable display system 802 and an external device 804. The wireless interface 806 includes transceivers for the display system 802 and for the external device 804. The external device 804 is a computing and communicating device. It may be a remote control type of device connecting to a general purpose computer. It may also be a general purpose computer connecting to a communication network such as the Internet. The external device may be carried by a vehicle or a person.

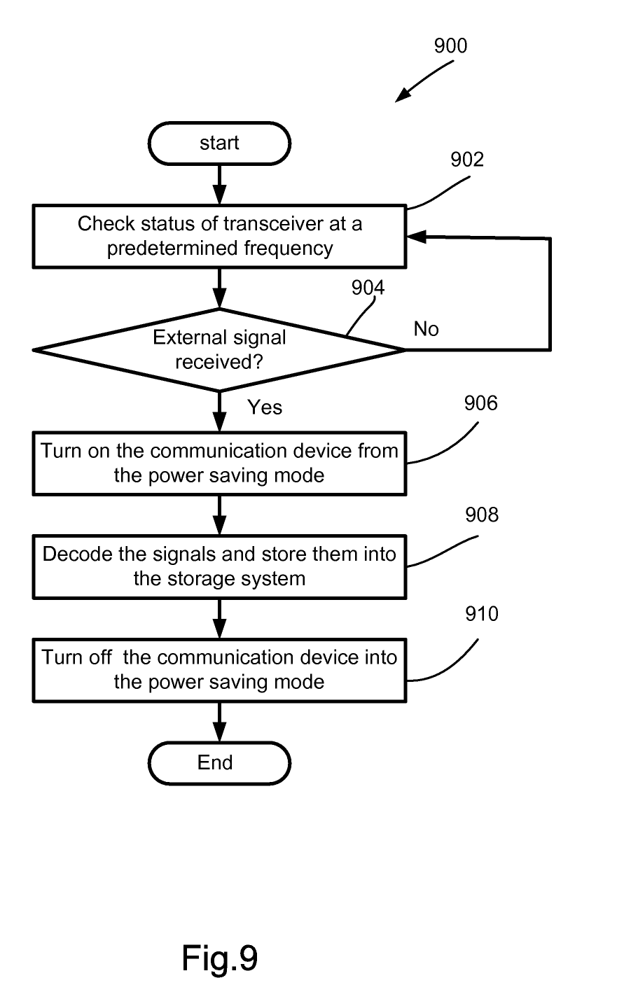

FIG. 9 is a flow chart for a process 900 that signals are received by a display system from an external device through a short range wireless communication according to one embodiment of the present invention. The process 900 starts with a step 902 that the transceiver of the display system is checked by the processor 406 at a predetermined frequency. If an external signal is received and the user's authenticity is verified at 904, the communication device 410 is switched on from a power saving mode at 906. The media contents and control data files from the external device are then received and decoded by the display system and are stored in the file storage system 408 at 908. After the operation is completed, the communication device 410 is switched back into the power saving mode at 910. The programmable display system will then be operated based upon the newly updated data.

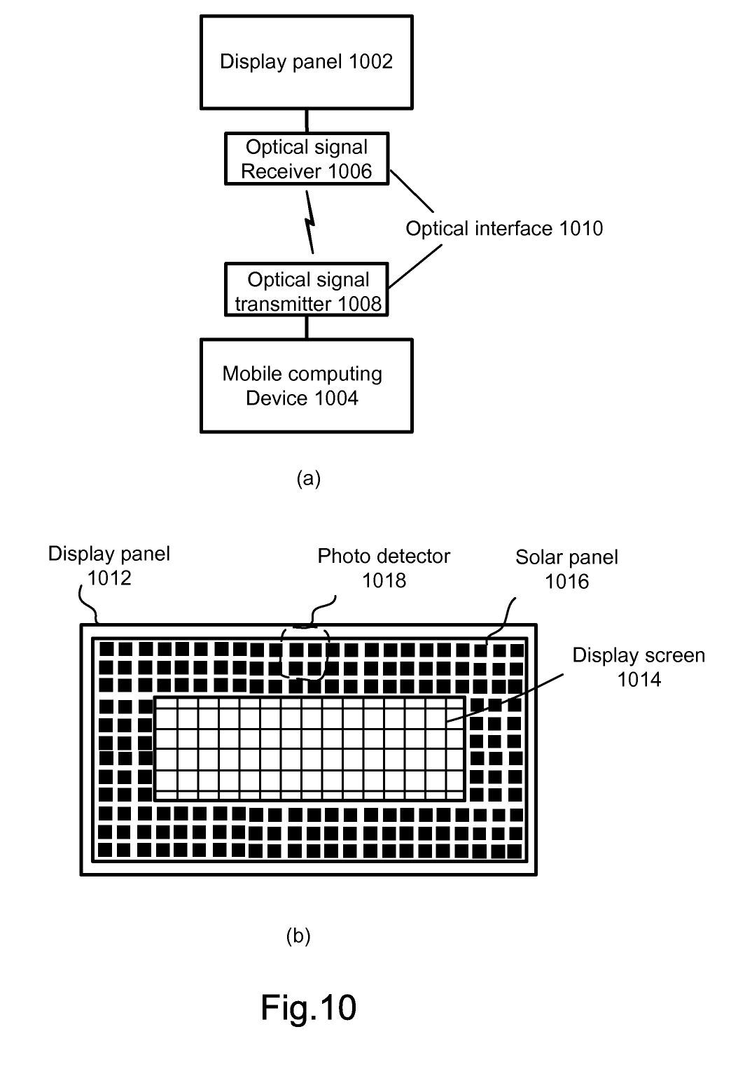

The communication between the programmable display system and the external device may be accomplished by other methods such as optical means. The present invention discloses various embodiments for the communication with low power consumption and low cost. FIG. 10A is a schematic diagram illustrating an optical communication between a programmable display system 1002 and an external device 1004. The programmable display system 1002 is integrated with an optical signal receiver 1006 and the external device 1004 is with an optical signal transmitter 1008. The external device 1004 may be a mobile computing and communicating device. The optical signal receiver 1006 may be a photo detector. The optical signal receiver 1006 and the optical signal transmitter 1008 form an optical communication interface 1010.

There are various implementations for integrating a photo detector (receiver) or a plurality of photo detectors into the programmable display system. There are also various implementations for short range communications using optical technologies. A visible light communication is our preferred embodiment in the present invention. Photo detector or detectors are typically manufactured by semiconductor manufacturing process and may be arranged onto the same layer as the solar cells. They are connected to the flexible PCB. The received optical signals are converted into electrical signals by the photo detector and are received by the processor after decoding into digital signals. FIG. 10B is a schematic diagram illustrating a display panel 1012 including a display screen 1014 and a plurality of solar cells 1016 forming the solar panel. A plurality of photo detectors 1018 are indicated in the figure. With the increased number of photo detectors, the alignment between the emitted light beam and the detector becomes easier. The signals are received when at least one photo detector receives the signals.

According to one embodiment of the present invention, one or multiple solar cells are used as photo detectors. Solar cells are diodes which convert light into electricity based upon photovoltaic effects. A diode can also be used as a photo detector. The selected solar cells used as photo detectors are connected to a voltage or a current sensing circuit to measure the variation of the electric signals generated by the photo detectors. When a modulated light beam is detected by the solar cells used as the photo detectors and is converted into electric signals, the sensing circuit receives signals. The received signals are then decoded accordingly and are sent to the processor. It should be noted that light beam size and solar cell size should be optimized to improve the response time of the solar cells to the variation of the light intensity. If the light beam size is too much smaller than the size of the solar cell used as the photo detector, the response time of the solar cell will limit the transmit rate of the optical signals. Furthermore, the solar cells used as photo detectors can still be served as the solar cells to convert light into electricity.

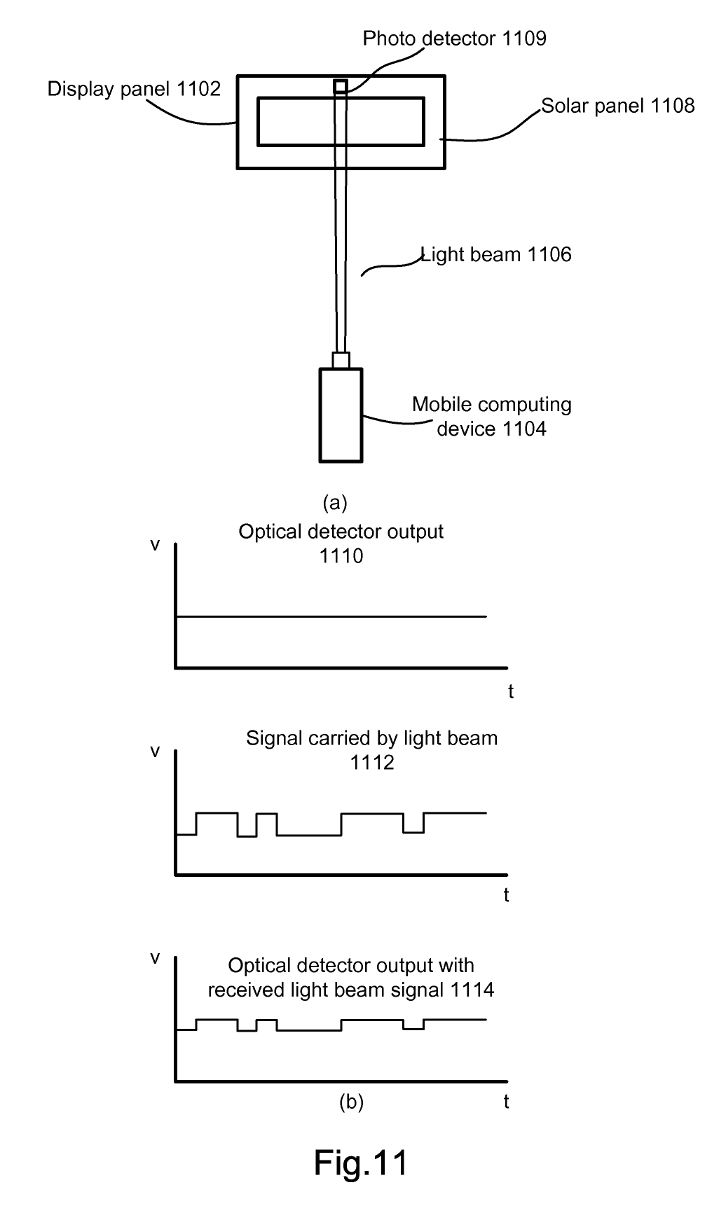

FIG. 11A is a schematic diagram illustrating the programmable displayed system 1102 receiving optical signals emitted from a mobile computing device 1104. The optical signals are carried by a modulated light beam 1106 and are received by a solar panel 1108 comprising photo detectors 1109. FIG. 11B shows the output changes of the solar cell 1109 used as photo detector. 1110 is the one when there is no received modulated optical light beam. 1112 is the modulated light beam and 1114 is the idealistic photo detector output when the modulated light beam is received by the photo detector.

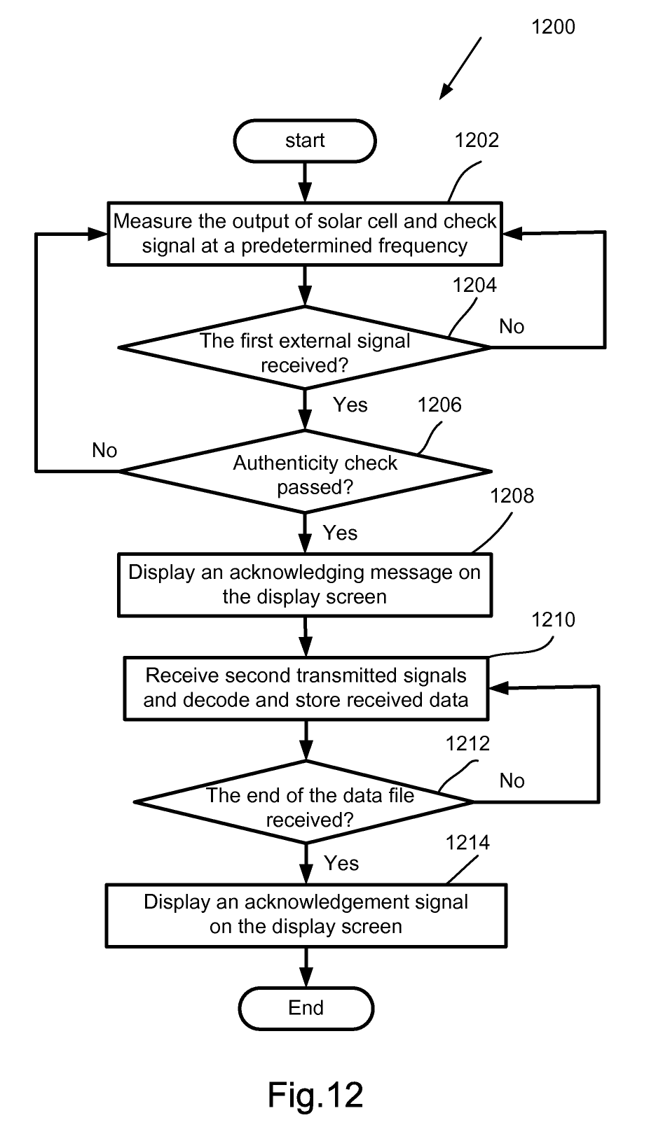

FIG. 12 is a flow chart for a process that signals are received by a display system from an external device through optical communication means according to an embodiment of the present invention. The process 1200 starts with a step 1202 that the outputs of photo detectors are checked at a predetermined frequency. According to one embodiment, some solar cells are configured as photo detectors and are connected to the voltage or the current sensing circuits. The outputs of these sensing circuits are monitored by the processor 406. If the processor 406 detects that the first signals are received by at least one photo detector at 1204, the user's authenticity is checked at 1206. If the authenticity check is passed, the processor 406 controls the display panel to display an acknowledging signal on the screen at 1208. The signal may be a text, a graphic and a multimedia message which is visible to the user. After receiving the acknowledging signals, the external device sends the second signals towards the display panel. At 1210, the photo detectors receive the signals and the received signals are decoded and are stored into file storage system 408. If the end of the signal is detected at 1212, an acknowledgement signal is then displayed on the display screen at 1214 and the process ends.

1. An apparatus for rendering media contents, the apparatus comprising:
a frame;
a display layer that displays the media contents;
a processor that controls operation of the apparatus;
a file storage system that stores media contents and other data;
a communication device that communicates with an external device or network;
a solar cell layer that converts solar energy into electricity; and
a battery that stores electricity generated by the solar cells or an external source.

2. The apparatus as recited in claim 1, further comprising:
a flexible Printed Circuit Board (PCB) layer coupled electrically and mechanically to the solar cell layers; and
a shock-absorbing material coupling the solar cell layer to the frame.

3. The apparatus as recited in claim 1, wherein the display layer is selected from a group of display devices including:
Liquid Crystal Display (LCD);
Light Emitting Diode (LED);
Organic Light Emitting Diode (OLED);
Plasma Display Panel (PDP); and
Electronic Paper Display (EPD).

4. The apparatus as recited in claim 1, wherein the solar cell layer is arranged in the areas that are not covered by the display layer.

5. The apparatus as recited in claim 1, wherein the solar cell layer is arranged underneath the display layer.

6. The apparatus as recited in claim 5, wherein said display layer is transparent or semi-transparent.

7. The apparatus as recited in claim 1, wherein the display layer is with a size smaller than that of the solar cell layer in both of horizontal directions.

8. The apparatus as recited in claim 1, wherein said communication device is a wireless communication device conforming to various IEEE standards and their amendments including IEEE 802.11 and/or IEEE 802.15.1 and/or IEEE 802.15.4.

9. The apparatus as recited in claim 1, wherein said communication device is an optical communication device which receives signals carried by a visible or an invisible beam of light emitted from the external device.

10. The communication device as recited in claim 9, wherein said optical communication device comprising at least one photo detector selected from a group of devices including:
a photo resistor;
a photo diode;
a photo transistor; and
a Charge Couple Device (CCD).

11. The communication device as recited in claim 10, wherein said photo detector comprising at least one solar cell which is also served as a part of the solar cell layer.

12. A method of rendering advertising messages to a plurality of users by employing a programmable display system powered by solar cells, which includes a display panel, a processor, a file storage system and a communication device, the method comprising:
receiving advertising messages and associated control data from an external device;
programming broadcasting based upon at least partially the received messages and data; and
broadcasting the advertising messages based upon the programming.

13. The method as recited in claim 12, wherein said programmable display system provides means for pre-storing advertising messages and operation programs before deployed for an outdoor operation in a location with direct exposure to the sun light.

14. The method as recited in claim 12, wherein said external device is a computing and communication device connected to a communication network including the Internet.

15. The method as recited in claim 12, wherein the communication device provides means to communicate with the external device through a wireless means conforming to various IEEE standards and their amendments including IEEE 802.11 and/or IEEE 802.15.1 and/or IEEE 802.15.4.

16. The method as recited in claim 12, wherein the communication device including at least one photo detector which provides means for receiving optical signal carried by a visible or invisible optical beam emitted from the external device.

17. The method as recited in claim 16, wherein said photo detector comprising at least one photo diode which is one of the solar cells converting the sun light into electricity.

18. A method of receiving media contents from an external device by a solar cell powered display system including a display panel, a processor, a communication device and a file storage device, the method comprising:
emitting signals from the external device for identifying its authenticity;
receiving the signals by the communication device of said display system;
displaying an acknowledging signal on the display panel by said display system if the authenticity check is passed;
transmitting media contents and control data from the external device;
receiving the transmitted contents and data by said display system; and
displaying an acknowledging signal on the display panel by said display system on the completion of receiving messages and data.

19. The method as recited in claim 18, wherein the communication device comprising a photo detector and the external device is a mobile computing device which includes an optical signal transmitter and is connected to the Internet.

20. The method as recited in claim 18, wherein said photo detector includes a photo diode which is at least one of solar cells.
